(19) United States
(12) Patent Application Publication
(10) Pub. No.: US 2025/0093617 A1
(43) Pub. Date: Mar. 20, 2025

(54) COSMETIC MIRROR

(71) Applicant: Shenzhen GHT Intelligent Technology Co., Ltd., Shenzhen (CN)

(72) Inventor: Xinhui Zeng, Shenzhen (CN)

(21) Appl. No.: 18/369,195

(22) Filed: Sep. 17, 2023

(51) Int. Cl. G02B 7/182; A45D 42/18; A45D 42/22

(52) U.S. Cl. CPC G02B 7/182; A45D 42/18; A45D 42/22

(57) ABSTRACT

The present application provides a cosmetic mirror comprising a first mirror body part and a second mirror body part in an opening/closing connection, wherein front surfaces of the first mirror body part and the second mirror body part are respectively provided with a first mirror surface and a second mirror surface, and a back surface of the first mirror body part is provided with an exposed third mirror surface.

### TECHNICAL FIELD

The present application relates to the technical field of mirrors, and in particular to a cosmetic mirror.

### BACKGROUND

In daily life, people often need to look good with their makeup at all times. Particularly for women, the cosmetic mirror that can be carried with a person can bring convenience for touch-ups at any time and any place. The existing cosmetic mirrors are mostly in an opening/closing structure. In any scenario, the cosmetic mirror needs to be opened to show the mirror surface inside for use, and then closed after use.

### SUMMARY

The present application provides a cosmetic mirror including a first mirror body part and a second mirror body part, wherein an opening/closing connection is formed between the first mirror body part and the second mirror body part. The first mirror body part and the second mirror body part are both provided with a front surface and a back surface arranged in a back-to-back manner, and the front surface of the first mirror body part is arranged opposite to the front surface of the second mirror body part. The front surface of the first mirror body part is provided with a first mirror surface, and the front surface of the second mirror body part is provided with a second mirror surface. The back surface of the first mirror body part is provided with an exposed third mirror surface.

### BRIEF DESCRIPTION OF THE DRAWINGS

FIG. 1 is a schematic structural view of an exemplary embodiment of a cosmetic mirror according to the present application in a closed state;

FIG. 2 is a schematic structural view of the cosmetic mirror corresponding to FIG. 1 in an open state;

FIG. 3 is an exploded structural view of the cosmetic mirror corresponding to FIG. 2;

FIG. 4 is a schematic structural view of an exemplary embodiment of a first housing of a cosmetic mirror according to the present application;

FIG. 5 is a schematic cross-sectional view of the first housing of the cosmetic mirror corresponding to FIG. 4;

FIG. 6 is a schematic cross-sectional view of a first mirror body part of the cosmetic mirror corresponding to FIG. 5;

FIG. 7 is an exploded structural view of an exemplary embodiment of a first housing of a cosmetic mirror according to the present application;

FIG. 8 is a schematic cross-sectional view of an exemplary embodiment of a first mirror body part of a cosmetic mirror according to the present application;

FIG. 9 is a schematic structural view of an exemplary embodiment of a cosmetic mirror according to the present application in a closed state;

FIG. 10 is a schematic structural view of an exemplary embodiment of a cosmetic mirror according to the present application in an open state;

FIG. 11 is a schematic cross-sectional view of an exemplary embodiment of a first mirror body part of a cosmetic mirror according to the present application;

FIG. 12 is a schematic structural view of an exemplary embodiment of a second mirror body part of a cosmetic mirror according to the present application;

FIG. 13 is a schematic structural view of an exemplary embodiment of a cosmetic mirror according to the present application in an open state;

FIG. 14 is a schematic structural view of an exemplary embodiment of a cosmetic mirror according to the present application in an open state;

FIG. 15 is a schematic structural view of an exemplary embodiment of a cosmetic mirror according to the present application in a closed state;

FIG. 16 is a schematic cross-sectional view of an exemplary embodiment of a first mirror body part of a cosmetic mirror according to the present application;

FIG. 17 is a schematic structural view of an exemplary embodiment of a cosmetic mirror according to the present application in an open state;

FIG. 18 is a schematic structural view of an exemplary embodiment of a cosmetic mirror according to the present application in an open state;

FIG. 19 is a schematic structural view of an exemplary embodiment of a cosmetic mirror according to the present application in an open state;

FIG. 20 is a schematic structural view of an exemplary embodiment of a third mounting bracket of a cosmetic mirror according to the present application.

### DETAILED DESCRIPTION

For ease of understanding of the present application, the present application will be described more fully below with reference to the related drawings. Preferred embodiments of the present application are given in the drawings. The present application can, however, be embodied in many different forms and should not be construed as limited to the embodiments set forth herein. Rather, these embodiments are provided such that the disclosure of the present application will be understood more thoroughly and completely.

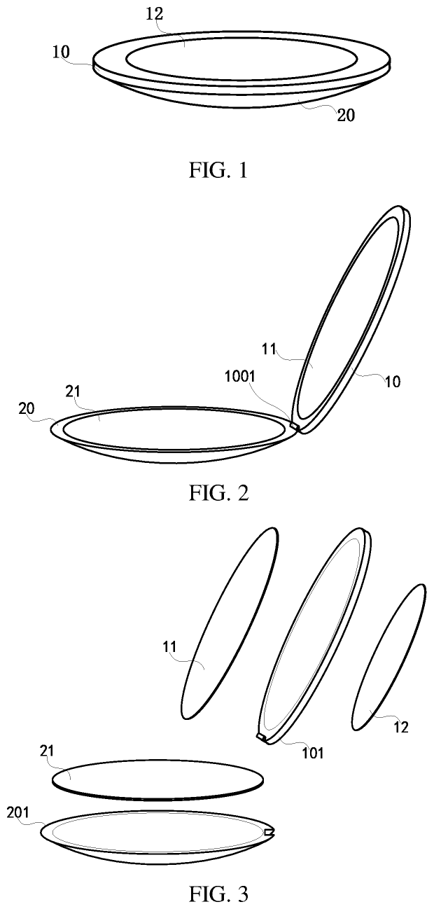

In an alternative embodiment of the present application, provided is a cosmetic mirror. With reference to FIGS. 1 and 2, the cosmetic mirror includes a first mirror body part 10 and a second mirror body part 20, wherein an opening/closing connection is formed between the first mirror body part 10 and the second mirror body part 20; the first mirror body part 10 and the second mirror body part 20 are both provided with a front surface and a back surface arranged in a back-to-back manner, and the front surface of the first mirror body part 10 is arranged opposite to the front surface of the second mirror body part 20 (i.e., surfaces of the first mirror body part 10 and the second mirror body part 20 opposite to each other when the cosmetic mirror is in a closed state); the front surface of the first mirror body part 10 is provided with a first mirror surface 11, and the front surface of the second mirror body part 20 is provided with a second mirror surface 21; the back surface of the first mirror body part 10 is provided with an exposed third mirror surface 12.

In the embodiment of the present application, an opening/closing connection is formed between the first mirror body part 10 and the second mirror body part 20, which means that the first mirror body part 10 and the second mirror body part 20 can achieve both open and closed states based on this connection relationship. It can be understood that a specific implementation of the opening/closing connection is not limited in this embodiment. For example, in some examples, the two may be in a hinge connection, a magnetic attraction connection, or the like. The hinge connection can ensure the reliability of the connection between the first mirror body part 10 and the second mirror body part 20 while ensuring switching between the open state and the closed state of the cosmetic mirror. The magnetic attraction connection can provide a more flexible switching mode of the open and closed states of the cosmetic mirror.

In some exemplary embodiments, when the cosmetic mirror is in a closed state, the first mirror surface 11 of the first mirror body part 10 and the second mirror surface 21 of the second mirror body part 20 are hidden inside and are not directly exposed outside, so that the first mirror surface 11 and the second mirror surface 21 can be protected from scratches or dust.

In some exemplary embodiments, the first mirror surface 11 and the second mirror surface 21 may be flexibly set in three types of a plane mirror, a concave mirror, and a convex mirror. The plane mirror can present a mirror image with the same proportion at the angle of mirror symmetry; the concave mirror can present a mirror image after stretching in the corresponding direction, that is, the original image can be magnified, and more details can be seen; the convex mirror can display more contents on the mirror surface, so that the field of view is increased, and interestingness can be enhanced to some extent. For example, one of the first mirror surface 11 and the second mirror surface 21 may be set to be one of a plane mirror, a concave mirror, and a convex mirror, and the other may be set to be one of the remaining two types, so that the user may flexibly and autonomously select the first mirror surface 11 or the second mirror surface 21 to be used as required to present the desired mirror image effect. Of course, in some other exemplary embodiments, the first mirror surface 11 and the second mirror surface 21 may be set to be the same type of mirror surface, for example, both being plane mirrors, concave mirrors, or convex mirrors. It can be understood that in some exemplary embodiments, a part of at least one of the first mirror surface 11 and the second mirror surface 21 is set to be one of a plane mirror, a concave mirror, and a convex mirror, and the other part is set to be at least one of the remaining two types, so that a plurality of mirror image effects can be exhibited by only one mirror surface, and the interestingness can be enhanced to some extent while increasing the application range of the first mirror surface 11 or the second mirror surface 21.

In the embodiment of the present application, the back surface of the first mirror body part 10 is also provided with an exposed third mirror surface 12, which means that the third mirror surface 12 and the first mirror surface 11 are arranged in a back-to-back manner. Since the third mirror surface 12 is directly exposed, when using the third mirror surface 12, a user enables the exposed third mirror surface 12 to directly face an object to be displayed (for example, the face, eyes, mouth, nose, or the like of the user) without the need to perform opening and closing operations on the cosmetic mirror, so that the cosmetic mirror is convenient and efficient to use, and is particularly suitable for emergency use in various emergency situations, which expands the usage scenario of the cosmetic mirror and enhances the user experience. It should be understood that the third mirror surface 12 in this embodiment may be in any one of three types of a plane mirror, a concave mirror, and a convex mirror. For example, in some exemplary embodiments, the type of the third mirror surface 12 may be set to be the same as that of the first mirror surface 11, both of which may be plane mirrors, concave mirrors, or convex mirrors. In some other exemplary embodiments, the type of the third mirror surface 12 may be set to be different from that of the first mirror surface 11, with the third mirror surface 12 being one of a plane mirror, a concave mirror, and a convex mirror, and the first mirror surface 11 is being one of the remaining two types. In still some other exemplary embodiments, a part of at least one of the third mirror surface 12 is set to be one of a plane mirror, a concave mirror, and a convex mirror, and the other part is set to be at least one of the remaining two types, so that a plurality of mirror image effects can be exhibited by the third mirror surface 12, and the interestingness can be enhanced to some extent while increasing the application range of the third mirror surface 12. The third mirror surface 12 may be set in a size similar to that of the first mirror surface 11, or smaller or larger than that of the first mirror surface 11. The first mirror surface 11 and the third mirror surface 12 are respectively arranged centrally on the front surface and the back surface of the first mirror body part 10 to ensure the aesthetics of the cosmetic mirror. Similarly, the second mirror surface 21 is also arranged centrally on the second mirror body part 20.

In some exemplary embodiments, the first mirror body part 10 includes a first housing, and at least one of the first mirror surface 11 and the third mirror surface 12 included in the first mirror body part 10 may be a mirror surface arranged on the first housing. For example, the first mirror surface 11 can be prepared in advance and then fixed to the front surface of the first housing; and/or the third mirror surface 12 can be prepared in advance and then fixed to the back surface of the first housing, or the first mirror surface 11 is formed by coating or electroplating (such as silver plating, copper plating, chrome plating, etc.) the front surface of the first housing with a material capable of forming a mirror surface, and/or the third mirror surface 12 is formed by coating or electroplating the back surface of the first housing with a material capable of forming a mirror surface. In some other exemplary embodiments, at least one of the first mirror surface 11 and the third mirror surface 12 may be formed as a part of the first housing itself. For example, at least a part of the front surface of the first housing is formed into a mirror surface as the first mirror surface 11 by a process of grinding and polishing or the like, and/or at least a part of the back surface of the first housing is formed into a mirror surface as the third mirror surface 12 by a process of grinding and polishing or the like. For example, the first housing may be a metal (e.g., silver, copper, steel, chrome, or the like) housing, and at least a part of the front surface and/or the back surface of the first housing may be formed into a mirror surface by a process of grinding and polishing or the like.

In some exemplary embodiments, the second mirror body part 20 includes a second housing, and the second mirror surface 21 included in the second mirror body part 20 may be a mirror surface arranged on the second housing or formed by at least a part of the front surface of the second housing. The forming method for the second mirror surface 21 may be referred, but is not limited to the forming method for the first mirror surface 11 described above, and will not be repeated herein.

For ease of understanding, this embodiment is exemplarily described below in conjunction with the drawings for a structure in which the first mirror surface 11, the second mirror surface 21, and the third mirror surface 12 are prepared in advance and then are respectively fixed to the first housing and the second housing. With reference to FIG. 3, the first mirror body part 10 includes a first housing 101, and a first mirror surface 11 and a third mirror surface 12 respectively arranged on the front surface and the back surface of the first housing 101. The second mirror body part 20 includes a second housing 201 and a second mirror surface 21 arranged on the front surface of the second housing 201, and the front surface of the first housing 101 is arranged opposite to the front surface of the second housing 201.

At least one of the first mirror surface 11, the second mirror surface 21, and the third mirror surface 12 may be a glass mirror surface, a plated mirror surface, or a metal mirror surface. The glass mirror surface may be an aluminum mirror or a silver mirror, and the metal mirror surface may be a metal mirror surface plate such as a stainless steel plate, a copper plate, and a silver plate with a surface that can be polished to form a mirror surface. The first mirror surface 11, the second mirror surface 21, and the third mirror surface 12 may be respectively arranged on the corresponding first housing 101 and the second housing 201 by a direct or indirect fixed connection with the first housing 101 and the second housing 201. The fixed connection includes a detachable fixed connection and a non-detachable fixed connection. The specific connections may include, but are not limited to, a bonding connection, a snap connection, a welding connection, a magnetic attraction connection, and the like. Taking the third mirror surface 12 fixed to the first housing by a magnetic attraction connection as an example, at least one of the third mirror surface 12 and the first housing 101 is provided with a magnetic attraction member, and the third mirror surface 12 is detachably fixed to the first housing 101 by the magnetic attraction member. When the third mirror surface 12 is directly arranged on the first housing 101, the third mirror surface 12 and the first housing 101 are each provided with a magnetic attraction member; when the third mirror surface 12 is indirectly fixed to the first housing 101 by another medium, a magnetic attraction member may be arranged on the medium, and a detachable connection between the third mirror surface 12 and the first housing 101 is realized based on the fixed connection between the medium and the first housing 101 and the magnetic attraction connection between the third mirror surface 12 and the medium.

According to the cosmetic mirror provided by the embodiment of the present application, the front surfaces of the first mirror body part 10 and the second mirror body part 20 are respectively provided with a first mirror surface 11 and a second mirror surface 21, so that the opening/closing mirror display function of the cosmetic mirror is realized. The back surface of the first mirror body part 10 is provided with an exposed third mirror surface 12, so that a user can directly use the third mirror surface 12 without opening the cosmetic mirror.

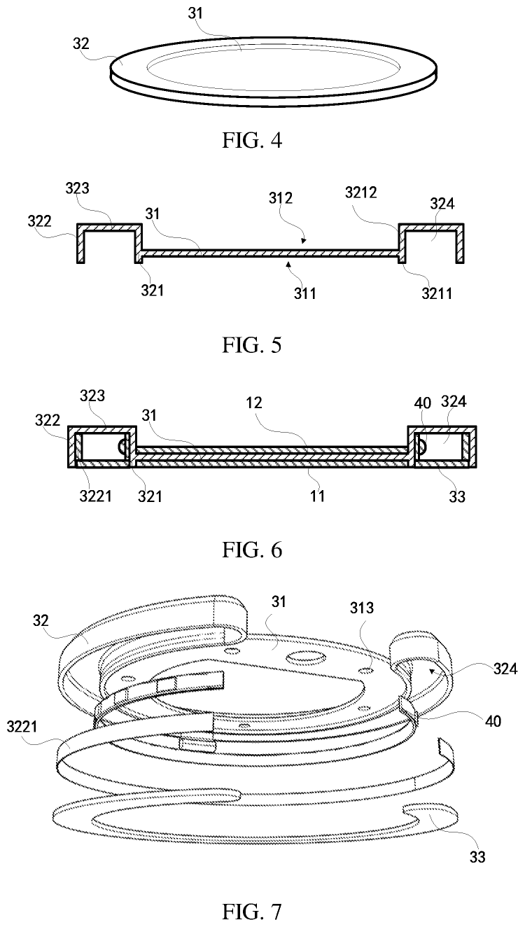

In some embodiments of the present application, in order to fill light for an object to be displayed (e.g., the face of a user) when the cosmetic mirror is used, with reference to FIGS. 4 to 6, the cosmetic mirror further includes a light-filling lamp arranged on one side of the first mirror body part 10, wherein the first light-filling lamp includes a lamp strip 40 and a lamp housing 32; the first housing 101 includes a support member 31, and the first mirror surface 11 and the third mirror surface 12 are respectively arranged on the front surface and the back surface of the support member 31; the lamp housing 32 is arranged around the support member 31, a lamp strip receiving cavity 324 is formed in the lamp housing 32, and the lamp housing 32 is at least partially light-transmitting; the lamp strip 40 is arranged in the lamp strip receiving cavity 324, and light emitted from the lamp strip 40 is emitted outwards through the lamp housing 32. When the light emitted from the first light-filling lamp irradiates the object being displayed, the object being displayed can be lightened, and the mirror image can be brightened accordingly, so that a good mirror display effect can be provided even in dark environments to allow the user to see more details, thereby improving the mirror effects. In some examples, the support devices, including a battery, a circuit board (not shown in the figure), and the like, required for the operation of the lamp strip 40 may be received by providing corresponding accommodating spaces inside at least one of the first housing 101 and the second housing 201, and a control key for controlling the operation of the lamp strip 40 may be provided on any exposed portion of the first housing 101 or the second housing 201, so that a user may directly operate the control key from the outside to control the first light-filling lamp. The specific form of the control key includes a physical key, a virtual key, or a touch key. In some other embodiments, the first light-filling lamp can be controlled by sound control, light control, or the like.

In some exemplary embodiments, with continued reference to FIGS. 5 and 6, the specific structure of the lamp housing 32 includes a first side wall 321, a second side wall 322, and a third side wall 323 integrally formed, wherein the first side wall 321 is close to the support member 31 and is integrally formed with the support member 31, thereby providing good integrity and a simple structure. For example, when the first housing 101 is a plastic member as a whole, the integrally formed structure described above can be formed by the method including, but not limited to, injection molding; when the first housing 101 is a metal member as a whole, the integrally formed structure described above is formed by the method including, but not limited to, cutting, forging, casting, and the like. In this example, the second side wall 322 is arranged opposite to the first side wall 321, the third side wall 323 is arranged between the first side wall 321 and the second side wall 322, and the first side wall 321, the second side wall 322, and the third side wall 323 form the lamp strip receiving cavity 324 with an opening in an enclosing manner, so that the lamp strip 40 can be conveniently installed through the opening. In some examples, the cosmetic mirror further includes a lamp housing cover 33 blocking the opening, thereby sealing the lamp strip 40 within the lamp strip receiving cavity 324 to provide protection therefor. At least a part of the light emitted from the lamp strip 40 can be at least emitted outwards from a region between the first side wall 321 and the second side wall 322. In an example shown in FIG. 6, the opening of the lamp strip receiving cavity 324 is located on the same side as the first mirror surface 11, the lamp housing cover 33 is correspondingly located on the same side as the first mirror surface 11, and the third side wall 323 is located on a side away from the first mirror surface 11. However, in some other examples, the opening of the lamp strip receiving cavity 324 can be arranged on the same side as the third mirror surface 12, the lamp housing cover 33 can be accordingly arranged on the same side as the third mirror surface 12, and the third side wall 323 can be arranged on the same side as the first mirror surface 11. The lamp housing cover 33 is located opposite to the third side wall 323, and the light emitted from the lamp strip 40 is emitted outwards at least partially from a region between the first side wall 321 and the second side wall 322, that is, from the third side wall 323 and/or the lamp housing cover 33 between the first side wall 321 and the second side wall 322.

In some examples of this embodiment, the first light-filling lamp may be set to fill light only to the orientation in which the third mirror surface 12 is located, in which case at least a part of the third side wall 323 in FIG. 6 may be set to be light-transmitting, and the other side walls of the lamp housing 31 and the lamp housing cover 33 may be set to be not light-transmitting, or the first light-filling lamp may be set to fill light only to the orientation in which the first mirror surface 11 is located, in which case at least a part of the lamp housing cover 33 in FIG. 6 may be set to be light-transmitting, and the lamp housing 31 may be set to be not light-transmitting. Moreover, since the first mirror surface 11 is arranged opposite to the second mirror surface 21, which means that they are on the same side when the cosmetic mirror is in the open state, the first light-filling lamp in this case can realize light filling to both the first mirror surface 11 and the second mirror surface 21 when the user is using either of them. In some other examples of this embodiment, the first light-filling lamp may be set to realize light filling to both sides of the first mirror surface 11 and the third mirror surface 12, in which case at least a part of the third side wall 323 and the lamp housing cover 33 may be light-transmitting. In the above examples, when the light filling can be performed to the orientation in which the third mirror surface 12 is located, the user can directly use the third mirror surface 12 in the light filling environment without opening the cosmetic mirror, so that the user experience can be further enhanced.

In some other examples of this embodiment, the support member 31 and the lamp housing 32 may not be in an integrally formed structure, that is, the support member 31 and the lamp housing 32 may be manufactured as two separate components and connected by a fixed connection, which may be a bonding connection, a snap connection, or the like. Furthermore, at least one of the support member 31 and the lamp housing 32 may be an integrally formed component itself, or may be formed by a plurality of components in a fixed connection.

In some exemplary embodiments, with continued reference to FIGS. 5 and 6, in order to better realize the limitation and installation of the first mirror surface 11 and the third mirror surface 12, the support 31 divides the first side wall 321 in a height direction into an upper side wall 3212 and a lower side wall 3211, wherein the lower side wall 3211 and the support member 31 form a first groove 311 in an enclosing manner, and the first mirror surface 11 is embedded in the first groove 311, wherein the first mirror surface 11 may be completely embedded in the first groove 311, or a part of the first mirror surface 11 is arranged in the first groove 311 and the other part may be exposed out of the first groove 311; the upper side wall 3212 and the support member 31 form a second groove 312 in an enclosing manner, and the third mirror surface 12 is embedded in the second groove 312, wherein the third mirror surface 12 may be completely embedded in the second groove 312, or a part of the third mirror surface 12 is arranged in the second groove 312 and the other part is exposed out of the second groove 312. The first mirror surface 11 and the third mirror surface 12 can be directly or indirectly fixedly arranged in the corresponding first groove 311 and second groove 312, respectively, by the method including, but not limited to, a direct bonding connection, a bonding connection by a medium, a snap connection, or a fixed connection based on interference fit.

In some exemplary embodiments, with continued reference to FIG. 6, in order to improve the light emitting efficiency of the first light-filling lamp and improve the light-filling brightness, the cosmetic mirror further includes a light reflection layer 3221 arranged on the second side wall 322 in an attached manner. The light reflection layer 3221 is arranged on the inner side of the second side wall 322, and when the light emitted from the lamp strip 40 irradiates the light reflection layer 3221, the light is reflected by the light reflection layer 3221 and then emitted outwards from a region between the first side wall 321 and the second side wall 322, so that the light emitting efficiency is improved, and the illumination brightness is improved. In this example, the manner in which the light reflection layer 3221 is arranged on the second side wall 322 includes setting the light reflection layer 3221 itself to be formed integrally with the second side wall 322, that is, the second side wall 322 itself is made of a material with high reflectivity, coating the second side wall 322 with a reflective coating, including a light-colored reflective layer such as a white oil layer, or setting the light reflection layer 3221 itself to be an independent reflective sheet, which is fixedly arranged on the second side wall 322.

In some exemplary embodiments, with reference to FIG. 7, when at least one of the first mirror surface 11 and the third mirror surface 12 is fixed to the support member 31 by an adhesive, a plurality of adhesive overflow holes 313 may be arranged on the support member 31. For one thing, the arrangement of the adhesive overflow holes 313 enables the adhesive to flow into the adhesive overflow holes 313 after being pressed, thereby flattening the first mirror surface 11 and/or the third mirror surface 12; for another, it can improve the bonding strength, reduce the weight of the support member 31, and reduce the consumption of raw materials, thereby reducing the cost.

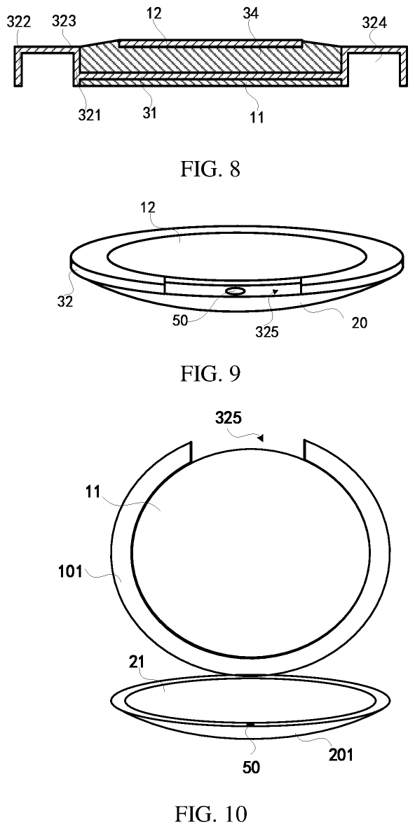

In some exemplary embodiments, with reference to FIGS. 5 and 8, in order to increase the degree of freedom of setting the size of the third mirror surface 12, the first housing 101 further includes a mirror surface carrier 34 embedded in the second groove 312 and blocking the second groove 312, and the third mirror surface 12 is embedded on the mirror surface carrier 34. Provided that the mirror surface carrier 34 has been arranged, the size and shape of the third mirror surface 12 can be flexibly set based on the mirror surface carrier 34 without being limited to the size and shape of the second groove 312. For example, the third mirror surface 12 may be set in a size smaller than that of the second groove 312 and in a shape inconsistent with that of the second groove 312, including but not limited to a heart shape, a cloud shape, and other non-regular shapes. Of course, it may also be set in a regular shape including a circle, an ellipse, a rectangle, and the like. In this example, the first groove 311 and the second groove 312 may be in a regular shape, including but not limited to a circle, an ellipse, a rectangle, a rounded rectangle, a regular octagon, and the like, and may also be set in a non-regular shape. The shapes of the third mirror surface 12 and the first groove 311, and the first groove 311 and the second groove 312 may be identical or different. It should be understood that the outline shape of the cosmetic mirror in this example may be a regular shape such as a circle, an ellipse, a rectangle, a rounded rectangle, or a regular octagon, or may be set in a non-regular shape. The setting of the above specific shapes is not limited in this example.

In some exemplary embodiments, with reference to FIGS. 9 and 10, in order to facilitate the control operation of the lamp strip 40, a notch 325 is formed on the lamp housing 32 arranged around the support member 31, that is, the lamp housing 32 is arranged around the support member 31 in a non-closed manner; the front surface of the second mirror body part 20 is provided with a control key 50 for controlling the lamp strip 40, wherein when the first mirror body part 10 and the second mirror body part 20 are in a closed state, the control key 50 is exposed through the notch 325, so that the control key 50 can be directly operated to realize the control of the lamp strip 40 without opening the cosmetic mirror, thereby improving the convenience of control. Moreover, the control key 50 is located in the notch 325, so that while facilitating the control, the risk that the cosmetic mirror is mistakenly triggered due to contact with other objects when the cosmetic mirror is placed in a user bag or pocket can be avoided as much as possible.

In some other examples, the control key 50 may be arranged on the back surface or side surface of the second mirror body part 20, or on the front surface, back surface, or side surface of the first mirror body part 10. The control key 50 may be directly arranged on the first housing 101 and the second housing 201, or may be directly arranged on the corresponding first mirror surface 11, the second mirror surface 21, and the third mirror surface 12.

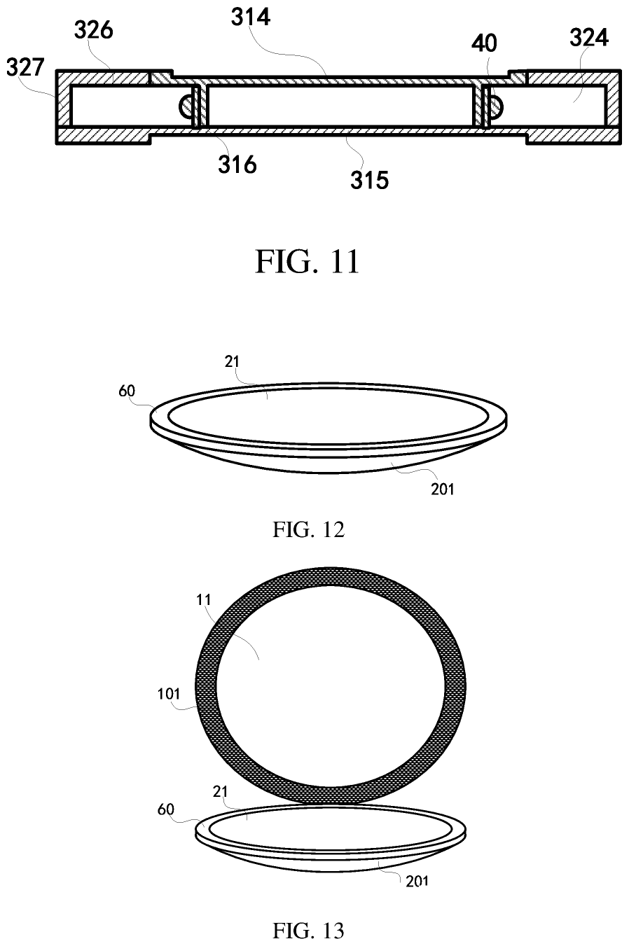

In some exemplary embodiments, with reference to FIG. 11, in order to improve the degree of freedom of assembling components in the cosmetic mirror, the first light-filling lamp of the cosmetic mirror may further have a structure as follows: the support member includes a first support sheet 314 and a second support sheet 315 in a fixed connection, wherein the first support sheet 314 and the second support sheet 315 are arranged in an up-and-down stacked manner, and an annular shading plate 316 is vertically arranged between the first support sheet 314 and the second support sheet 315; the lamp housing includes a fourth side wall 326 and a fifth side wall 327 integrally formed, wherein the fourth side wall 326 is arranged around an outer edge of the first support sheet 314 and is opposite to the second support sheet 315, and the fifth side wall 327 is arranged opposite to the annular shading plate 316 and is adjacent to the second support sheet 315; the first support sheet 314, the annular shading plate 316, the second support sheet 315, the fourth side wall 326, and the fifth side wall 327 form a lamp strip receiving cavity 324 in an enclosing manner. The fixed connection formed between the first support sheet 314 and the second support sheet 315 may be detachable, which means that the first support sheet 314 and the second support sheet 315 may be separately formed and then forms a fixed connection by a snap connection, threaded fixation, or the like. The first support sheet 314 and the second support sheet 315 are arranged in an up-and-down stacked manner. However, they are not tightly stacked, and there is a certain gap therebetween, which is realized by an annular shading plate 316 arranged therebetween. In the case of the support member, the lamp housing correspondingly includes a fourth side wall 326 and a fifth side wall 327 integrally formed, wherein the fourth side wall 326 is arranged on the same side as the first support sheet 314 and is arranged around an outer edge of the first support sheet 314; the fifth side wall 327 is arranged opposite to the annular shading plate 316, that is, the fifth side wall 327 is also vertically arranged, with the bottom connected to an outer edge of the second support sheet 315, so that the fourth side wall 326, the fifth side wall 327, the first support sheet 314, the second support sheet 315, and the annular shading plate 316 together form the lamp strip receiving cavity 324 for receiving the lamp strip 40, and the lamp strip 40 is arranged at the position where the annular shading plate 316 is located. By adjusting the position of the annular shading plate 316, the deployment position of the lamp strip 40 can be adjusted correspondingly, and a sufficient light-mixing distance can eliminate dark spots in the emitted light from the first light-filling lamp, so that more uniform light is emitted.

As shown in FIG. 11, the annular shading plate 316 may be integrally formed with the first support sheet 314. Alternatively, the annular shading plate may also be integrally formed with the second support sheet. Alternatively, the annular shading plate includes an upper component and a lower component, which are integrally formed with the first support sheet and the second support sheet, respectively, and then spliced to form a complete annular shading plate after the first support sheet and the second support sheet are fixedly connected. The lamp strip 40 is arranged at the position where the annular shading plate 316 is located, has a light emitting surface facing away from the annular shading plate 316, and emits light outwards at least through the fourth side wall 326 and the fifth side wall 327. In addition, the first support sheet 314 and the second support sheet 315 may be set to be partially light-transmitting, that is, the lamp strip 40 may also emit light through the first support sheet 314 and the second support sheet 315.

In some exemplary embodiments, with reference to FIG. 12, the cosmetic mirror includes a second light-filling lamp 60 arranged on one side of the second mirror body part 20, and the second light-filling lamp 60 is arranged around the second mirror surface 21 and is arranged on the second housing 201. After the second light-filling lamp 60 is arranged, light filling can be performed by the second light-filling lamp 60 when the cosmetic mirror is opened and the first mirror surface 11 or the second mirror surface 21 is used.

In this example, the second light-filling lamp 60 may have a specific structure similar to that of the first light-filling lamp, that is, the second light-filling lamp 60 also includes a lamp housing (not shown in the figure) and a lamp strip (not shown in the figure); the lamp housing of the second light-filling lamp 60 may be formed integrally with the second housing 201. The second light-filling lamp 60 may also have a structure different from that of the first light-filling lamp, and in one example, the second light-filling lamp 60 may only include a lamp strip, and this lamp strip is directly embedded in the second housing 201, and emits light with the second housing as a lamp housing.

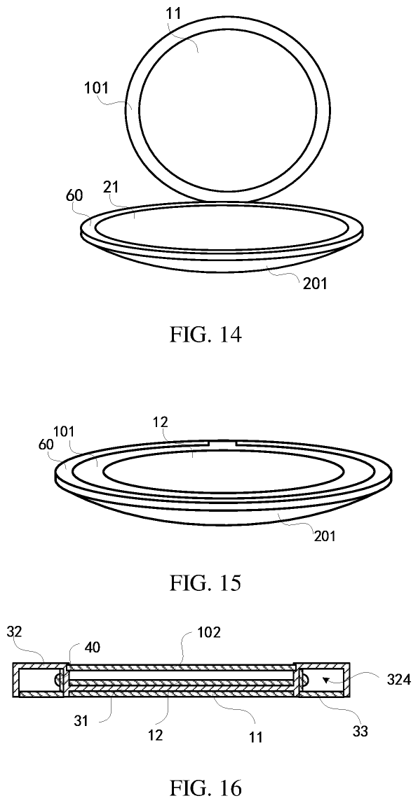

In order to realize a situation where the light filling can be realized by the second light-filling lamp 60 when the third mirror surface 12 is used, one exemplary embodiment may be referred to FIG. 13, in which it may be provided that when the first mirror body part 10 and the second mirror body part 20 are in a closed state, a projection region of the first housing 101 projected onto the front surface of the second housing 201 has an overlapping region with the second light-filling lamp 60, and a housing region of the first housing 101 corresponding to the overlapping region is at least partially light-transmitting, so that light emitted from the second light-filling lamp 60 can penetrate through the light-transmitting region of the first housing 101, and thus light filling can be realized through the second light-filling lamp 60 when the exposed third mirror surface 12 is used without opening the cosmetic mirror. For example, one example of the light-transmitting region of the first housing 101 may be referred to the filled portion in FIG. 13. Another exemplary embodiment is referred to FIG. 14, in which it may be provided that when the first mirror body part 10 and the second mirror body part 20 are in a closed state, a projection region of the first housing 101 projected onto the front surface of the second housing 201 enclosed by an outer edge of the second light-filling lamp 60. In this case, the outline size of the first housing 101 is smaller than that of the second light-filling lamp 60, so that an avoidance space is formed, and thus the light emitted from the second light-filling lamp 60 can directly penetrate through the edge of the first housing 101 and exit to the side where the third mirror surface 12 is located to realize the light filling.

In some exemplary embodiments, with reference to FIG. 15, when the first mirror body part 10 and the second mirror body part 20 are in a closed state, the second light-filling lamp 60 is entirely located outside the projection range of the first housing 101, that is, the second light-filling lamp 60 is directly wrapped outside the projection of the first housing 101. All light emitted from the second light-filling lamp 60 under this structure can be emitted to a region where the third mirror surface 12 is located, and the second light-filling lamp 60 can be arranged to be flush with the front surface of the second housing 201 or higher than the front surface of the second housing 201, so that when the cosmetic mirror is in a closed state, the second light-filling lamp 60 is arranged around the first housing 101.

In some exemplary embodiments, when the first mirror body part 10 and the second mirror body part 20 are in a closed state, an outer edge region of the second light-filling lamp 60 is located outside the projection range of the first housing 101, and an inner edge region of the second light-filling lamp is located inside the projection range of the first housing 101. The light emitted from the outer edge region of the second light-filling lamp 60 under this structure can be emitted to a region where the third mirror surface 12 is located, the light emitted from the inner edge region is covered by the first housing 101, and light filling can be realized just based on the light emitted from the outer edge region. Under this structure, in order to ensure that the first mirror body part 10 and the second mirror body part 20 can be completely closed, the second light-filling lamp 60 is set to be in a height lower than the front surface of the second housing 201 or at most flush with the front surface of the second housing 201, so that the cosmetic mirror can be normally closed.

It should be understood that, in some embodiments, the cosmetic mirror may be provided with only one of the first light-filling lamp and the second light-filling lamp 60 illustrated above, or may be provided with both as required.

In some exemplary embodiments, in order to protect the exposed third mirror surface 12 from scratches, with reference to FIG. 16, the cosmetic mirror includes a protective cover 102 arranged on the back surface of the first housing 101 and covering the third mirror surface 12. The connection between the protective cover 102 and the first housing 101 may be a fixed connection or a flexible connection. In the case of a fixed connection, the protective cover 102 should be set to be transparent so as not to interfere with the use of the third mirror surface 12; in this case, the hardness of the protective cover 102 is high to prevent the protective cover 102 from being scratched, resulting in the inability to see the third mirror surface 12 clearly. In some embodiments, the material of the protective cover 102 is a high-hardness light-transmitting material such as glass, sapphire, or the like.

In the case where the connection between the protective cover and the first housing is a flexible connection, the protective cover can be set to be nontransparent or transparent. For example, the protective cover is a silica gel cover or a magnetic attraction cover, or is connected with the first housing through a sliding groove, and when needed, only a simple toggle can expose the third mirror surface, which is more convenient as compared to the case where there is no third mirror surface set and the cosmetic mirror needs to be opened.

In some exemplary embodiments, with continued reference to FIG. 2, the opening/closing connection between the first mirror body part 10 and the second mirror body part 20 includes a rotatable connection realized by a hinge 1001. Depending on the needs of the use scenario, an angle range of the rotatable connection between the first mirror body part 10 and the second mirror body part 20 may be 0°-90°, which means that the cosmetic mirror may have an angle range from closing to opening at a right angle; or the angle range may be 0°-120°, which means that cosmetic mirror may have an angle range from closing to opening at 120°; or the angle range may be 0°-180°, which means that the cosmetic mirror may have an angle range from closing to opening in a flattened state, and when the cosmetic mirror is at the angle of opening in a flattened state, the first mirror surface 11 and the second mirror surface 21 are substantially located on the same plane; or the angle range may be 0°-270°, which means that the cosmetic mirror may have an angle range from closing to opening at an angle of 270°; or the angle range may be 0°-360°, which means that the cosmetic mirror may have an angle range from closing to reverse closing, and when the cosmetic mirror is in a reversely closed state, the first mirror surface 11 and the second mirror surface 21 are directly exposed and separately used as a housing of the cosmetic mirror, and the first mirror surface 11 or the second mirror surface 21 can be directly used.

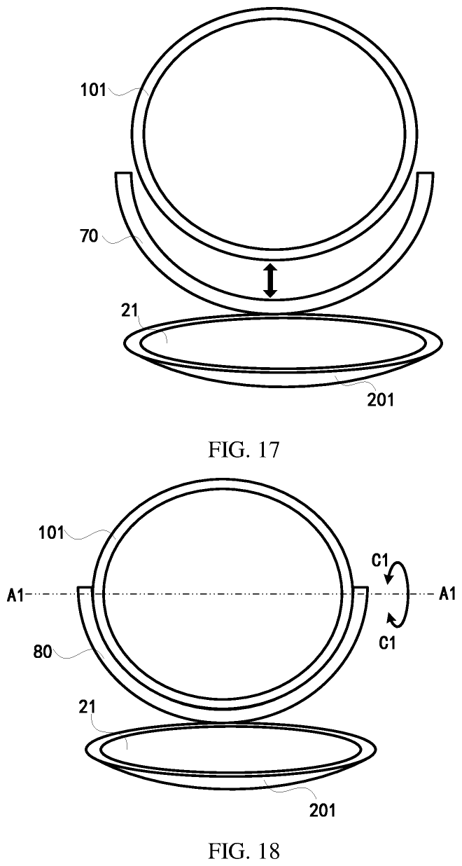

In some exemplary embodiments, the front surface and the back surface of the first housing are relatively unfixed, and may be switched and adjusted according to the real-time status of the cosmetic mirror. In one exemplary embodiment, with reference to FIG. 17, the cosmetic mirror further includes a first mounting bracket 70. The first mounting bracket 70 has a lower end in a rotatable connection with the second housing 201, wherein the rotatable connection is used for realizing an opening/closing connection between the first mounting bracket 70 and the second housing 201, that is, for further realizing an opening/closing connection between the first housing 101 and the second housing 201; the first mounting bracket 70 has an upper end arranged halfway around the outside of the first housing 101 and forming a detachable connection with the first housing 101, which includes, but is not limited to a snap connection or a magnetic attraction connection. Under this structure, based on the switching of the detachable connection, the orientations of the first mirror surface 11 and the third mirror surface 12 respectively arranged on the front surface and the back surface of the first housing 101 can be adjusted accordingly, that is, when the cosmetic mirror is in a closed state, the first mirror surface 11 can be exposed, or the third mirror surface 12 can be exposed. The front surface of the first housing 101 in the embodiment of the present application represents a surface closer to the orientation in which the second housing 201 is located in the current state, and for the first housing 101, the front surface and the back surface can be switched according to the detachable connection between the first mounting bracket 70 and the first housing 101. After the first housing 101 is detached from the first mounting bracket 70, the orientation of the first housing 101 can be reversed, so as to enable switching between the front surface and the back surface of the first housing 101, and switching between the corresponding first mirror surface 11 and the corresponding third mirror surface 12.

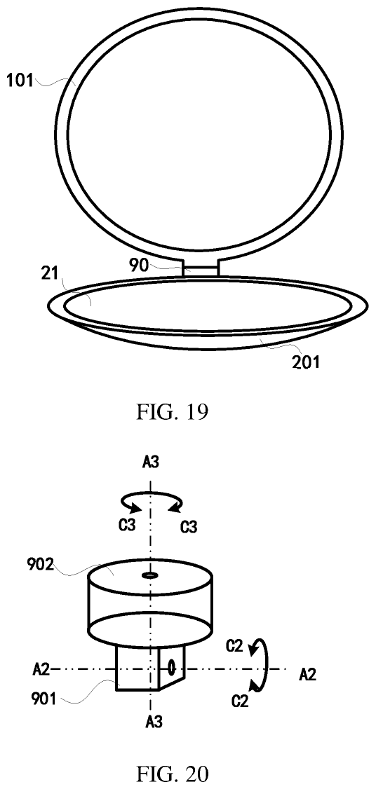

In another exemplary embodiment, with reference to FIG. 18, the cosmetic mirror further includes a second mounting bracket 80. The second mounting bracket 80 has a lower end in a rotatable connection with the second housing 201, wherein the rotatable connection is used for realizing an opening/closing connection between the second mounting bracket 80 and the second housing 201, that is, for further realizing an opening/closing connection between the first housing 101 and the second housing 201; the second mounting bracket 80 has an upper end arranged halfway around or around the outside of the first housing 101 and forming a rotatable connection with the first housing 101 through a first rotation axis A1. Under this structure, when the first housing 101 rotates around the first rotation axis A1, switching between orientations of the first mirror surface 11 and the third mirror surface 12 respectively arranged on the front surface and the back surface of the first housing 101 can be realized. When the cosmetic mirror is in a closed state, it can be presented in a form that exposes the first mirror surface 11 or the third mirror surface 12. As shown in FIG. 18, the first housing 101 is rotated at a rotation angle of C1 relative to the second mounting bracket 80 based on the first rotation axis A1, so as to enable switching between orientations of the front surface and the back surface of the first housing 101, and switching between orientations of the corresponding first mirror surface 11 and the corresponding third mirror surface 12.

In another exemplary embodiment, with reference to FIGS. 19 and 20, the cosmetic mirror further includes a third mounting bracket 90. The third mounting bracket 90 has a lower end 901 in a rotatable connection with the second housing 201, wherein the rotatable connection is used for realizing an opening/closing connection between the third mounting bracket 90 and the second housing 201, that is, for further realizing an opening/closing connection between the first housing 101 and the second housing 201; the third mounting bracket 90 has an upper end 902 forming an axially rotatable connection with the first housing 101, so that the first housing 101 can rotate around the axially rotatable connection, and a flip operation of the front surface and the back surface of the first housing 101 is realized, that is, switching between orientations of the first mirror surface 11 and the third mirror surface 12 respectively arranged on the front surface and the back surface of the first housing 101 is realized. A rotation axis A2 of the axially rotatable connection is perpendicular to a rotation axis A3 of the rotatable connection between the lower end of the third mounting bracket 90 and the second housing 201, and under this structure, after the first housing 101 is flipped over based on the axially rotatable connection, when the cosmetic mirror is in a closed state, the first mirror surface 11 and the third mirror surface 12 respectively arranged on the front surface and the back surface of the first housing 101 are switched in orientation states towards the second mirror surface 21 and away from the second mirror surface 21, respectively. As shown in FIG. 20, the lower end 901 of the third mounting bracket and the second housing rotate in a rotation direction C2 based on the rotation axis A2, the upper end 902 of the third mounting bracket and the first housing rotate in a rotation direction C3 based on the rotation axis A3, and the rotation axes A2 and A3 are spatially perpendicular to each other.

In some exemplary embodiments, the cosmetic mirror further includes a fourth mirror surface. The fourth mirror surface is located on the back surface of the second housing, and the specific arrangement manner of the fourth mirror surface may be referred, but is not limited to that of any one of the first mirror surface 11, the second mirror surface 21, and the third mirror surface 12, which will not be repeated here.

It should be understood that the application of the present application is not limited to the above examples, and that modifications or changes may be made by those of ordinary skill in the art based on the above description, and all such modifications and changes are intended to fall within the protection scope of the appended claims of the present application.

What is claimed is:

1. A cosmetic mirror comprising a first mirror body part and a second mirror body part, wherein an opening/closing connection is formed between the first mirror body part and the second mirror body part; the first mirror body part and the second mirror body part are both provided with a front surface and a back surface arranged in a back-to-back manner, and the front surface of the first mirror body part is arranged opposite to the front surface of the second mirror body part; the front surface of the first mirror body part is provided with a first mirror surface, and the front surface of the second mirror body part is provided with a second mirror surface; the back surface of the first mirror body part is provided with an exposed third mirror surface.

2. The cosmetic mirror according to claim 1, wherein one of the first mirror surface and the second mirror surface is a plane mirror, and the other is a concave mirror; the third mirror surface is a plane mirror or a concave mirror.

3. The cosmetic mirror according to claim 1, wherein the third mirror surface is a glass mirror surface, a plated mirror surface, or a metal mirror surface.

4. The cosmetic mirror according to claim 1, wherein the first mirror body part comprises a first housing, and the second mirror body part comprises a second housing, wherein the first housing and the second housing are both provided with a front surface and a back surface arranged in a back-to-back manner, and the front surface of the first housing is arranged opposite to the front surface of the second housing; the first mirror surface and the second mirror surface are respectively arranged on the front surfaces of the first housing and the second housing; the third mirror surface is arranged on the back surface of the first housing.

5. The cosmetic mirror according to claim 4, wherein at least one of the third mirror surface and the first housing is provided with a magnetic attraction member, and the third mirror surface is detachably fixed to the first housing through the magnetic attraction member.

6. The cosmetic mirror according to claim 4, wherein the cosmetic mirror further comprises a first light-filling lamp, wherein the first light-filling lamp comprises a lamp strip and a lamp housing; the first housing comprises a support member, and the first mirror surface and the third mirror surface are respectively arranged on a front surface and a back surface of the support member; the lamp housing is arranged around the support member, a lamp strip receiving cavity is formed in the lamp housing, and the lamp housing is at least partially light-transmitting; the lamp strip is arranged in the lamp strip receiving cavity, and light emitted from the lamp strip is emitted outwards through the lamp housing.

7. The cosmetic mirror according to claim 6, wherein the lamp housing comprises a first side wall, a second side wall, and a third side wall integrally formed, wherein the first side wall is close to the support member and is integrally formed with the support member, the second side wall is arranged opposite to the first side wall, the third side wall is arranged between the first side wall and the second side wall, and the first side wall, the second side wall, and the third side wall form the lamp strip receiving cavity with an opening in an enclosing manner; the cosmetic mirror further comprises a lamp housing cover blocking the opening; at least a part of the light emitted from the lamp strip is emitted outwards from a region between the first side wall and the second side wall.

8. The cosmetic mirror according to claim 7, wherein the support member divides the first side wall in a height direction into an upper side wall and a lower side wall, wherein the lower side wall and the support member form a first groove in an enclosing manner, and the first mirror surface is embedded in the first groove; the upper side wall and the support member form a second groove in an enclosing manner, and the third mirror surface is embedded in the second groove.

9. The cosmetic mirror according to claim 8, wherein the first housing further comprises a mirror surface carrier embedded in and blocking the second groove, and the third mirror surface is embedded on the mirror surface carrier.

10. The cosmetic mirror according to claim 8, wherein the cosmetic mirror further comprises a light reflection layer arranged on the second side wall in an attached manner.

11. The cosmetic mirror according to claim 6, wherein the support member comprises a first support sheet and a second support sheet in a fixed connection, wherein the first support sheet and the second support sheet are arranged in an up-and-down stacked manner, and an annular shading plate is vertically arranged between the first support sheet and the second support sheet; the lamp housing comprises a fourth side wall and a fifth side wall integrally formed, wherein the fourth side wall is arranged around an outer edge of the first support sheet and is opposite to the second support sheet, and the fifth side wall is arranged opposite to the annular shading plate and is adjacent to the second support sheet; the first support sheet, the annular shading plate, the second support sheet, the fourth side wall, and the fifth side wall form the lamp strip receiving cavity in an enclosing manner.

12. The cosmetic mirror according to claim 6, wherein a notch is formed on the lamp housing arranged around the support member, and the front surface of the second mirror body part is provided with a control key for controlling the lamp strip, wherein when the first mirror body part and the second mirror body part are in a closed state, the control key is exposed through the notch.

13. The cosmetic mirror according to claim 4, wherein the cosmetic mirror further comprises a second light-filling lamp arranged on the second housing, wherein the second light-filling lamp is arranged around the second mirror surface.

14. The cosmetic mirror according to claim 13, wherein when the first mirror body part and the second mirror body part are in a closed state, a projection region of the first housing projected onto the front surface of the second housing has an overlapping region with the second light-filling lamp, and a housing region of the first housing corresponding to the overlapping region is at least partially light-transmitting.

15. The cosmetic mirror according to claim 13, wherein when the first mirror body part and the second mirror body part are in a closed state, a projection region of the first housing projected onto the front surface of the second housing is enclosed by an outer edge of the second light-filling lamp.

16. The cosmetic mirror according to claim 4, wherein the cosmetic mirror comprises a protective cover arranged on the back surface of the first housing and covering the third mirror surface.

17. The cosmetic mirror according to claim 1, wherein the opening/closing connection between the first mirror body part and the second mirror body part comprises a rotatable connection having a rotation angle range of 0°-360°.

18. The cosmetic mirror according to claim 4, wherein the cosmetic mirror further comprises a first mounting bracket, wherein the first mounting bracket has a lower end in a rotatable connection with the second housing, and an upper end arranged halfway around the outside of the first housing and forming a detachable connection with the first housing.

19. The cosmetic mirror according to claim 4, wherein the cosmetic mirror further comprises a second mounting bracket, wherein the second mounting bracket has a lower end in a rotatable connection with the second housing, and an upper end arranged halfway around or around the outside of the first housing and forming a detachable connection with the first housing through a first rotation axis.

20. The cosmetic mirror according to claim 4, wherein the cosmetic mirror further comprises a third mounting bracket, wherein the third mounting bracket has a lower end in a rotatable connection with the second housing, and an upper end forming an axially rotatable connection with the first housing, and a rotation axis of the axially rotatable connection is perpendicular to a rotation axis of the rotatable connection between the lower end of the third mounting bracket and the second housing.
